(19) United States
(12) Patent Application Publication
(10) Pub. No.: US 2018/0210999 A1
(43) Pub. Date: Jul. 26, 2018

(54) CABLE ROUTING IN AIRCRAFT

(71) Applicant: AIRBUS OPERATIONS GMBH, Hamburg (DE)

(72) Inventors: Johannes GONNSEN, Hamburg (DE); Marcel ZENKER, Hamburg (DE)

(21) Appl. No.: 15/927,826

(22) Filed: Mar. 21, 2018

Related U.S. Application Data
(63) Continuation of application No. PCT/EP2016/075147, filed on Oct. 20, 2016.

(30) Foreign Application Priority Data
Oct. 20, 2015 (DE) 102015117842.7

(51) Int. Cl. G06F 17/50; B64D 11/02; B64D 11/00

(52) U.S. Cl. CPC G06F 17/5095; B64D 11/02; B64D 11/0007; G01M 1/125; G06F 2217/02; G06F 2217/36; B64D 11/0015

(57) ABSTRACT

An aircraft configurator for calculating locations of consumers and routes along which consumers are to be connected to corresponding suppliers of the aircraft. A computing unit can calculate different connection routes and select the connection route where a key performance indicator is optimal and takes into account additional installations that influence the route. Through this it possible to increase the efficiency in the production of the aircraft and the efficiency in the operation of the aircraft.

### CROSS-REFERENCE TO RELATED AND/OR PRIORITY APPLICATION(S)

This application is a continuation of international patent application number PCT/EP2016/075147, having an international filing date of Oct. 20, 2016, which claims priority to German patent application number DE 102015117842.7, having a filing date of Oct. 20, 2015. The content of the referenced applications is incorporated by reference herein.

### TECHNICAL FIELD

Embodiments of the invention relate to the configuration of aircraft. In particular, the disclosure relates to an aircraft configurator for calculating locations of consumers and routes along which consumers are to be connected to corresponding suppliers, a method of calculating locations of consumers in an aircraft and routes along which consumers are to be connected to corresponding suppliers, a program element and a computer readable medium.

### BACKGROUND

Various measures can be taken to increase the efficiency of the operation of aircraft. For example, it is possible to use more efficient aircraft engines, which are characterized by reduced fuel consumption. Also, modified wing airfoil and fuselage shapes may be used to enhance the aircraft's resistance and buoyancy characteristics. In certain applications, it may be useful to provide so-called winglets at the ends of the wings, which may improve the aerodynamic properties of the aircraft.

### BRIEF SUMMARY

It is an object of the disclosed subject matter to further improve the efficiency of aircraft.

This object is solved by the subject matters of the independent claims. Further developments of the disclosed subject matter will become apparent from the dependent claims and the following description.

A first aspect of the disclosure relates to an aircraft configurator for calculating locations of consumers and routes along which consumers are to connect to corresponding suppliers. The aircraft configurator is, for example, a computer-aided system which has a data storage on which comprehensive structural data of the aircraft and the components to be installed therein are stored. In particular, information about the geometry of the aircraft, and about the consumers and suppliers to be installed therein or the consumers and suppliers being available for installation, respectively, are stored in the data storage.

An input unit is provided which is adapted to input the installation locations and the type of consumers to be installed. In addition, a computing unit is provided which is adapted to identify a supplier to which a corresponding consumer is to be connected and to calculate a number of alternative routes along which the consumer may be connected to the supplier.

After the computing unit has calculated alternative line or cable routes, along which the lines or cables may run to connect the consumer to its associated supplier, the computing unit may identify that of the calculated routes, in which a so-called key performance indicator or a (mathematical) function (e.g. a sum) of several, for example differently weighted key performance indicators of the aircraft are optimal, e.g. in terms of the length of the aircraft or its weight. For example, it may be provided that the one key performance indicator or the function (more precisely, the value of the function) from a plurality of key performance indicators is as small as possible.

Thus, the aircraft configurator is able to calculate and output the optimal cable route for the intended use of the aircraft.

The key performance indicator is, for example, the weight of the aircraft, the distance of the center of gravity of the aircraft from a desired position of the center of gravity, or the installation time required to install the consumer and to establish the connection between the consumer and the supplier.

Thus, in a simple case, it may be provided that it is ensured that the total weight of the aircraft is as low as possible. In another case, it may be ensured that the center of gravity of the aircraft is as close as possible to the optimum center of gravity, as through this, fuel may be saved. If, for example, priority is given to assembling the aircraft in as little time as possible, the key performance indicator to be optimized may be the installation time.

It may be provided that not only one of these key performance indicators is optimized, but rather a function of a plurality of key performance indicators is optimized, which, for example, may be weighted differently. Thus, it may be provided that the selected cable route ensures that, on the one hand, the weight of the aircraft is as low as possible, but on the other hand, it does not exceed a certain maximum construction time and, moreover, that the distance of the center of gravity from the optimum center of gravity position does not exceed a certain threshold.

Also, the system may be adapted to allow the use of standard cables, as this may reduce installation and manufacturing costs.

In addition, it may be provided that the computing unit changes the user-entered installation location of a consumer to be installed on its own, in order to further optimize (for example, reduce) the key performance indicator or the function, respectively, or the function of the differently weighted key performance indicators.

Furthermore, an input unit for inputting the key performance indicator may be provided.

According to one embodiment of the invention, the computing unit is adapted to identify consumers whose installation locations are not to be changed. Thus, the user may prevent the computing unit from changing the installation locations of certain consumers itself in order to optimize the key performance indicator or the sum of different key performance indicators, for example to reduce them.

According to one embodiment of the invention, the consumers are, for example, aircraft toilets, sinks, kitchen appliances, vents, lights, loudspeakers and/or display devices, seat supplies, communication systems such as on-board telephones, cabin crew displays, service counters. The corresponding suppliers are, for example, water tanks, fuel cells, fuel tanks, air sources or air conditioning components or, generally, power or data sources.

According to one embodiment of the invention, the computing unit is adapted to create an installation plan for the consumer and further comprises an output unit for outputting the installation plan to a user.

This installation plan may be limited to providing information about the installation locations of consumers and suppliers as well as the corresponding routes to be used for the connections between consumers and suppliers. The installation plan may contain additional information, such as information about the type and design of the consumers and suppliers to be installed. The computing unit may be programmed to exchange a user-selected consumer with another consumer if this thereby results in optimizing the corresponding key performance parameter or the sum of the key performance parameters, respectively. The computing unit may also be adapted to change the design of a consumer, for example the position of the connection interfaces via which the consumer is connected to the line or the cable, respectively.

It may also be provided that the installation plan includes or at least takes into account all cabin installations as well as the structural components of the aircraft, which in part have an effect on the cable route to be fed through. In particular, the computing unit may be programmed not only to calculate alternative routes and possibly to change the location of one or more consumers or suppliers, but also to change the location and/or design of another installation or structural element of the aircraft to achieve the desired goal, namely the optimization of a key performance indicator or a function of key performance indicators, respectively.

Another aspect of the disclosed subject matter relates to a method for calculating locations of consumers in an aircraft and routes along which consumers are to be connected to corresponding suppliers. Initially information about the geometry of the aircraft and about installable consumers and suppliers are stored. Furthermore, installation locations and type of consumers to be installed are entered and a supplier is identified, to which the corresponding consumer is to be connected. Subsequently, installations influencing the route are identified and considered for the route in order to limit the solution space of the possible routes. Thereupon, various alternative routes along which the consumers can be connected to the corresponding suppliers are calculated and the one computed route is identified in which a key performance indicator or a function of several differently weighted key performance indicators of the aircraft is optimized or is as beneficious as possible.

Another aspect of the disclosed subject matter relates to a program element that, when executed on an computing unit of an aircraft configurator, instructs the computing unit to perform the following steps: retrieving information about the geometry of the aircraft and consumers and suppliers installable therein; Receiving of the installation locations and the type of consumers to be installed; Identifying a supplier to which the corresponding consumer is to be connected; Calculating various alternative routes along which the consumer can be connected to the supplier; Identifying the calculated route where a key performance indicator or function is optimized from several differently weighted key performance indicators of the aircraft.

Another aspect of the disclosed subject matter relates to a computer-readable medium on which the program element described above is stored.

In the following, embodiments of the invention will be described with reference to the figures. The illustrations in the figures are schematic and not drawn to scale. If the same reference symbols are used in the following description of the figures, these designate the same or similar elements.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows an aircraft configurator according to an embodiment of the invention.

FIG. 2 shows the description of a route element using description logic.

FIG. 3 shows alternative cable routes according to an embodiment of the invention.

FIG. 4 shows a flowchart of a method according to an embodiment of the invention.

FIG. 5 shows frames of an aircraft.

FIG. 6 shows a cross section of the fuselage of an aircraft, divided into different areas.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

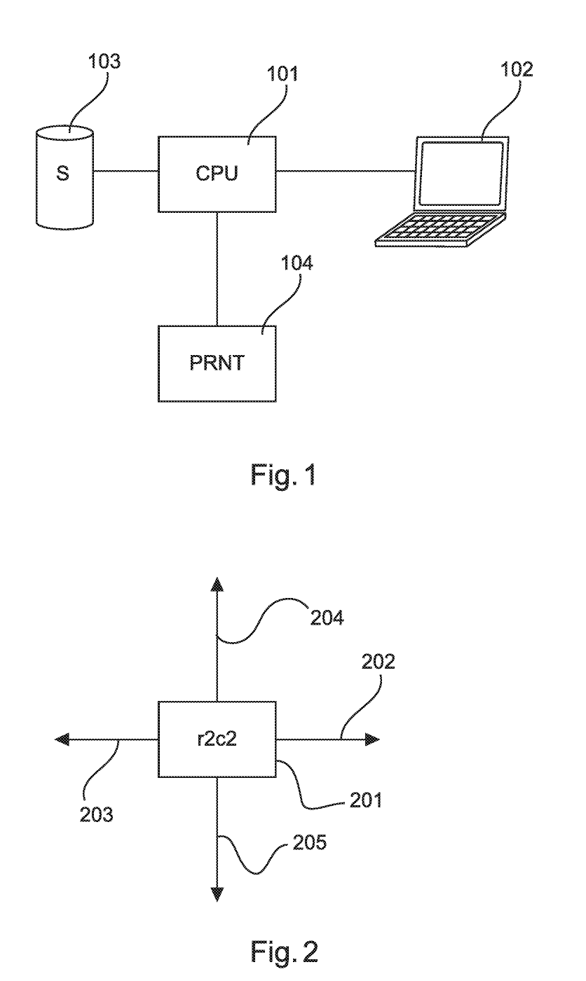

FIG. 1 shows an aircraft configurator according to an embodiment of the invention. The aircraft configurator is used to calculate locations of installation of electrical or other consumers in an aircraft, and routes along which consumers are to be connected to corresponding suppliers in the aircraft.

The aircraft configurator comprises a computing unit 101 adapted to identify a utility to which one or more corresponding consumers are to be connected and to calculate alternative routes along which consumers are connectable to the utility. For this purpose, the computing unit requires comprehensive data, which are stored in the data storage 103, and which in particular include information about the geometry of the aircraft and about consumers and suppliers which are installable in the aircraft.

In addition, the computing unit 101 is connected to an input unit 102, which is adapted for inputting the installation locations and the type of consumers to be installed.

Furthermore, an output unit 104, for example in the form of a printer or a display, is provided, via which the installation and connection diagram generated by the computing unit 101 may be output. The output may be in the form of a PD (Principle Diagram) of an FD (Functional Diagram) or a WD (Wire Diagram).

In order to be able to calculate the position of the installation locations of the consumers and suppliers as well as the routes of the connections between those two groups, the computing unit may, for example, use a three-dimensional grid which maps the geometry of the aircraft and its installations. Starting from this three-dimensional grid, the computing unit may now position a specific consumer at a certain point and then calculate possible cable and/or cable routes from the consumer to the corresponding supplier.

This process may then be carried out for all consumers and suppliers. It may be provided that the user himself determines the position of one, several, or all consumers. In any case, the computing unit may be programmed to change the position of one, or more, or all consumers (unless the user has prohibited this for one or more consumers), followed by a re-calculation of the corresponding cable routes.

Now the computing unit may compare whether the new positions and cable routes are “more beneficial” than the previous ones. If this is the case, for example, certain positions can be defined as fixed and other positions or cable routes may be varied again to achieve an even better result. This iterative process may be performed until a selected key performance indicator or function of multiple key performance indicators (for example, this may be a sum of different key performance indicators that are weighted equally or differently) are optimized to an acceptable, predetermined magnitude.

Both, the consumers and suppliers to be installed in the aircraft, as well as the further installations to be installed therein, as well as the cables and lines that can be used, may be defined by way of description logic. An example of this is shown in FIG. 2, in which a position indicator r2, c2 is shown, which is described with logical statements in the form of description logic. Thus, the position indicator 201 may be arranged to the right of the installation (see arrow 203), to the left of an installation (see arrow 202), over the installation (see arrow 205) or under the installation (see arrow 204).

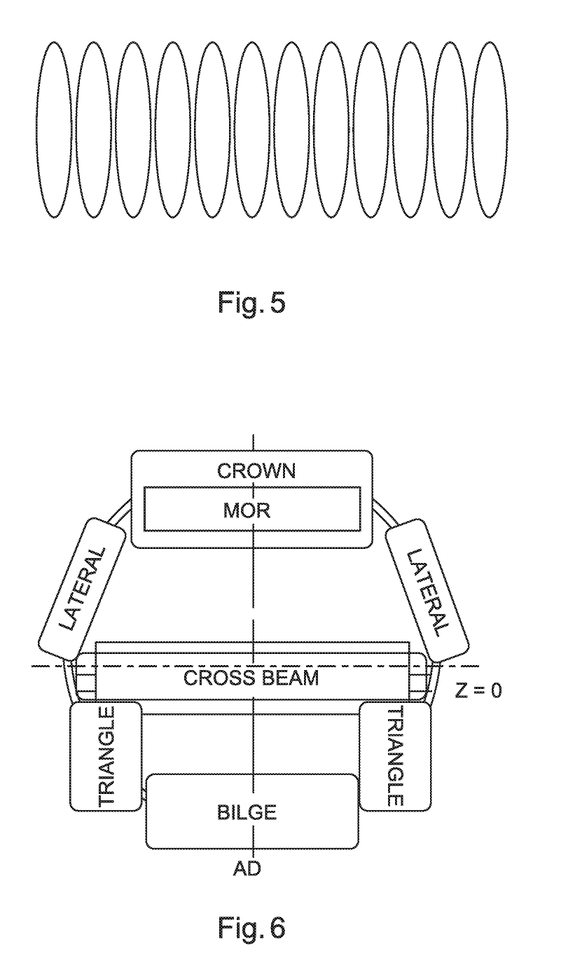

A fundamental consideration is that the aircraft or at least a certain area of the aircraft, for example the fuselage or the passenger cabin, is subdivided into conceptional areas of space. Those spatial regions may be predetermined, for example, by the frame regions in the x-direction (see FIG. 5). These different regions may also be split further in the y-z plane (see FIG. 6, which shows a cross section of the fuselage). The x-axis extends in the direction of flight, i.e. along the longitudinal axis of the aircraft, the z-axis is the vertical axis and the y-axis is the transverse axis.

After the division of the available space into sub-areas and rasterizing the room, which defines the installability of the consumers (each taking into account already existing structural components, such as frames and stringers, as well as the configuration of the cabin) the selection of consumers to be installed takes place. This is followed by fixing the installation locations of the consumers.

After performing these steps, the aircraft configuration is optimized taking into account one or more key performance indicators (e.g. total weight, installation time, usability of standard cables, center of gravity).

As a result, the computing unit outputs, for example, an installation plan for the consumers indicating the position and type of consumers as well as the corresponding line and/or cable routes. The use of description logic describes the functional, possible links between consumers, cables and wires, suppliers, and other components of the aircraft.

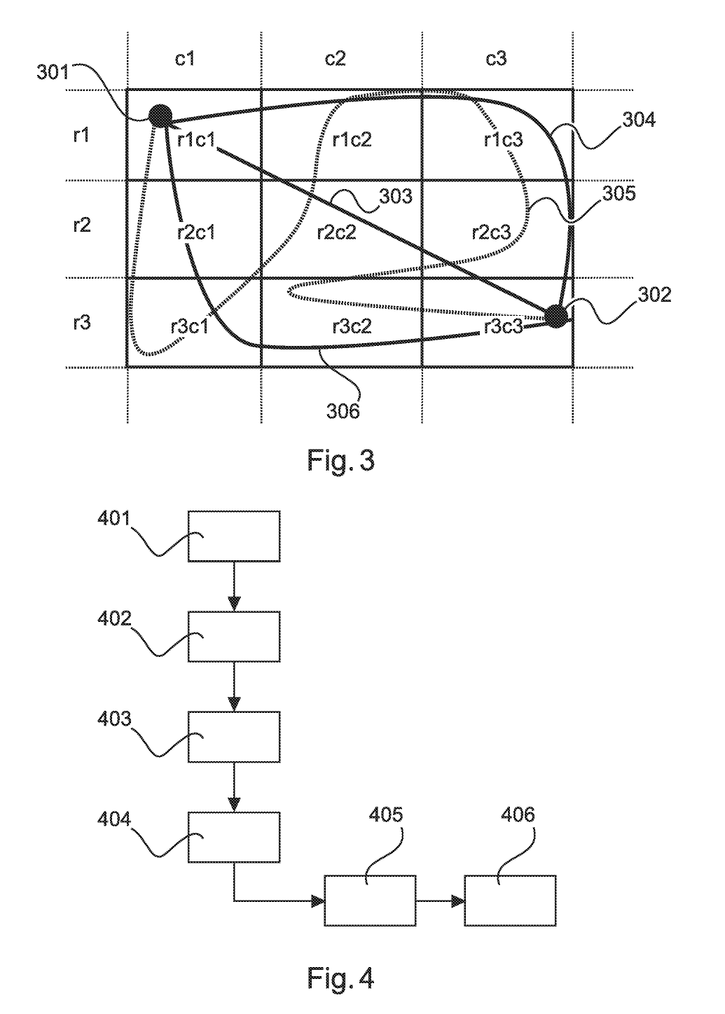

FIG. 3 shows a possible result of the method described above. Locations 301 and 302 indicate the positions of a consumer and a supplier to be connected to each other. The direct route leads diagonally through the aircraft cabin (see 303). Alternative routes are designated by lines 304, 305, 306. Route 306 takes into account geometric factors such as the shape of the fuselage, the shape and position of structural components such as frames and stringers, and brackets attached thereto.

The aircraft configurator compares the various alternative line and cable routes 303 to 306 and identifies the route for which a selected key performance indicator or, for example, a sum of weighted selected key performance indicators is most optimized (e.g., lowest). This route will then be chosen for the creation of the aircraft.

FIG. 4 shows a flowchart of a method according to an embodiment of the invention.

In step 401, information about the geometry of the aircraft and about installable consumers and suppliers from a database is retrieved by a computing unit. In step 402, the computing unit receives installation locations and type of consumers to be installed from a user, and in step 403, the computing unit identifies a particular supplier to which a corresponding consumer is to be connected. In step 404, various alternative routes along which the consumer is connectable to the provider are calculated, and in step 405, those of the calculated routes are identified in which a key performance indicator or a sum of several key performance indicators of the aircraft is minimal. In step 406, a corresponding, finished installation plan is output.

In addition, it should be noted that “comprising” and “having” does not exclude other elements or steps, and “a” or “an” does not exclude a plurality. It should also be appreciated that features or steps described with reference to any of the above embodiments may also be used in combination with other features or steps of other embodiments described above. Reference signs in the claims are not to be considered as limitations.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. An aircraft configurator for calculating installation locations of consumers and routes along which consumers are to be connected to corresponding suppliers, comprising:
a data storage storing information about the geometry of the aircraft and consumers and suppliers installable therein;
an input unit adapted to input the installation locations and the type of consumers to be installed; and
a computing unit adapted to identify a supplier to which the corresponding consumer is to be connected and to calculate alternative routes along which the consumer is connectable to the utility;
wherein the computing unit is further adapted to identify the calculated route in which a key performance indicator or a sum of a plurality of differently weighted key performance indicators of the aircraft is optimized and wherein the identified calculated route takes into account additional installations in the aircraft influencing the route.

2. The aircraft configurator according to claim 1, wherein the key performance indicator is the weight of the aircraft, the distance of the center of gravity of the aircraft from a desired position of a center of gravity, or the installation time required to install the consumer and establish the connection between the consumer and the supplier.

3. The aircraft configurator according to claim 1, wherein the input unit is adapted to input the key performance indicator.

4. The aircraft configurator according to claim 1, wherein the computing unit is adapted to change the installation location of a consumer to be installed to optimize the at least one key performance indicator.

5. The aircraft configurator according to claim 1, wherein the computing unit is adapted to identify consumers whose locations are not to be changed.

6. The aircraft configurator according to claim 1, wherein the consumers are toilets, sinks, vents, lights, speakers, displays, kitchen appliances, seat supplies, communication systems such as on-board telephones, cabin crew displays, and service counters.

7. The aircraft configurator according to claim 1, wherein the computing unit is adapted to create a schedule of installation for the consumers, and further comprising an output unit for outputting the installation plan.

8. A method for calculating the locations of consumers in an aircraft and routes along which consumers are to be connected to corresponding suppliers, comprising the steps of:
storing information about geometry of the aircraft and consumers and suppliers installable therein, as well as additional installations affecting a route;
entering the installation locations and the type of consumers to be installed;
identifying a supplier to which the corresponding consumer is to be connected;
calculating various alternative routes along which the consumer is connectable to the utility; and
identifying the calculated route in which a key performance indicator or a sum of a plurality of differently weighted key performance indicators of the aircraft is optimal and which additional installations in the aircraft affecting the route are considered.

9. A computer-readable medium comprising program instructions that, when executed on an computing unit of an aircraft configurator, instructs the computing unit to perform a method comprising the steps of:
retrieving information about geometry of the aircraft and consumers and suppliers installable therein, as well as additional installations affecting a route;
accepting the installation locations and the type of consumers to be installed;
identifying a supplier to which the corresponding consumer is to be connected;
calculating various alternative routes along which the consumer is connectable to the utility; and
identifying the calculated route in which a key performance indicator or a sum of a plurality of differently weighted key performance indicators of the aircraft is minimal and wherein the identified calculated route takes into account additional installations in the aircraft influencing the route.
